(19) United States
(12) Patent Application Publication
(10) Pub. No.: US 2007/0299374 A1
(43) Pub. Date: Dec. 27, 2007

(54) VIBRATORY EXERCISE DEVICE

(75) Inventors: Phillip E. Gesotti, Manassas, VA (US); Nicholas J. Nagumy, Manassas, VA (US); Amy J. McCullough, Manassas, VA (US)

Correspondence Address: FOGG & POWERS LLC, 10 SOUTH FIFTH STREET, SUITE 1000, MINNEAPOLIS, MN, 55402, US

(73) Assignee: LOCKHEED MARTIN CORPORATION, Bethesda, MD (US)

(21) Appl. No.: 11/426,462

(22) Filed: Jun. 26, 2006

(51) Int. Cl. A61H 1/00

(52) U.S. Cl. 601/79; 601/71; 601/72

(57) ABSTRACT

A vibratory exercise device comprises a control unit adapted to determine when to provide vibratory cues, wherein the control unit is adapted to divide the duration of a cue pattern period into a plurality of segments, and to assign vibratory cues to one or more of the plurality of segments. The vibratory exercise device also comprises a vibration actuator coupled to the control unit and adapted to provide vibratory cues in response to control signals received from the control unit at the start of each segment assigned a vibratory cue, and a housing adapted to house the control unit and the vibration actuator, wherein a user is able to feel the vibratory cues when in contact with the housing.

### BACKGROUND

Neurological disorders, such as Parkinson's disease (PD), as well as aging can damage nerves of the peripheral nervous system (peripheral neuropathy) resulting in peripheral sensory deficits. Peripheral neuropathy can also be a complication of Type II diabetes which is becoming more prevalent in the aging baby boomer population. In addition, dementia may be a cause of spatial and temporal perception deficits.

Although exercise has been shown to be beneficial to quality of life and may even slow progression of chronic diseases like Parkinson's disease, it may be difficult to initiate the motor function due to the disorienting nature of sensory deficits. For example, one feature of Parkinson's disease is akinesia/bradykinesia (inability to initiate movement and slowness of movement, respectively). Parkinson's disease affects not only the spatial quality of movement, but also affects the ability to properly time the movements.

However, these features are more pronounced during self-initiated actions in contrast to stimulus-initiated movements. The common scenario of ‘paradoxical kinesia’, where PD patients are able to significantly improve motor function with correct external sensory cueing, is empirical evidence that even PD patients with advanced disease may benefit from exercise programs employing cueing devices. Cues are also beneficial in helping other individuals suffering from peripheral sensory deficits to initiate movement during exercise.

For the reasons stated above, and for other reasons stated below which will become apparent to those skilled in the art upon reading and understanding the present specification, there is a need in the art for a device to provide sensory cues.

### SUMMARY

The above-mentioned problems and other problems are resolved by the present invention and will be understood by reading and studying the following specification.

In one embodiment, a vibratory exercise device is provided. The vibratory exercise device comprises a control unit adapted to determine when to provide vibratory cues, wherein the control unit is adapted to divide the duration of a cue pattern period into a plurality of segments, and to assign vibratory cues to one or more of the plurality of segments. The vibratory exercise device also comprises a vibration actuator coupled to the control unit and adapted to provide vibratory cues in response to control signals received from the control unit at the start of each segment assigned a vibratory cue, and a housing adapted to house the control unit and the vibration actuator, wherein a user is able to feel the vibratory cues when in contact with the housing.

In another embodiment, a vibratory exercise system is provided. The vibratory exercise system comprises a communication link, a plurality of vibratory exercise devices, and a control apparatus adapted to provide control signals to each of the plurality of vibratory exercise devices via the communication link. Each vibratory exercise device comprises a control unit adapted to determine when to provide vibratory cues, wherein the control unit is adapted to divide the duration of a cue pattern period into a plurality of segments, and to assign vibratory cues to one or more of the plurality of segments, and one or more vibration actuators coupled to the control unit and adapted to provide vibratory cues in response to control signals received from the control unit. The control unit in each of the plurality of vibratory exercise devices determines when to provide vibratory cues based on the control signals received from the control apparatus.

In another embodiment, receiving cue parameters in a vibratory exercise device, the vibratory exercise device having a control unit and a vibration actuator located in a housing. The method also comprises calculating the timing of vibratory cues with the control unit based on the cue parameters received, and instructing the vibration actuator to produce vibratory cues based on the calculated timing of vibratory cues.

### DRAWINGS

Embodiments of the present invention can be more easily understood and further advantages and uses thereof more readily apparent, when considered in view of the description of the embodiments and the following figures in which:

FIG. 1 is a high level block diagram of a vibratory exercise device according to one embodiment of the present invention.

FIG. 2 is a diagram of a timing sequence used in one embodiment of the present invention for providing vibratory cues.

FIG. 3 is a vibratory exercise device according to one embodiment of the present invention.

FIGS. 4A-4D depict components of a vibratory exercise device according to one embodiment of the present invention.

FIG. 5 is a diagram showing an exercise aid system according to one embodiment of the present invention.

FIG. 6 is a flow chart showing a method of facilitating movement during exercise according to one embodiment of the present invention.

Like reference numbers and designations in the various drawings indicate like elements.

### DETAILED DESCRIPTION

In the following detailed description, reference is made to the accompanying drawings that form a part hereof, and in which is shown by way of illustration specific illustrative embodiments in which the invention may be practiced. These embodiments are described in sufficient detail to enable those skilled in the art to practice the invention, and it is to be understood that other embodiments may be utilized and that logical, mechanical and electrical changes may be made without departing from the scope of the present invention. It should be understood that the exemplary methods illustrated may include additional or fewer steps or may be performed in the context of a larger processing scheme. Furthermore, the methods presented in the drawing figures or the specification are not to be construed as limiting the order in which the individual steps may be performed. The following detailed description is, therefore, not to be taken in a limiting sense.

Embodiments of the present invention enable sensory cues to be provided to a user in an effective and safe manner. In particular, embodiments of the present invention provide vibratory cues from a portable exercise device which enables users suffering from peripheral sensory deficits to engage more effectively in exercise as well as help other users regulate their movements during exercise routines. Additionally, the use of vibratory cues reduces costs and time in producing embodiments of the present invention for use by individuals. The costs are reduced because the vibratory nature of the cues does not require approval from the Food and Drug Administration (FDA) or other government agency, unlike electrical stimuli. Therefore the expenses involved in obtaining government approval can be avoided.

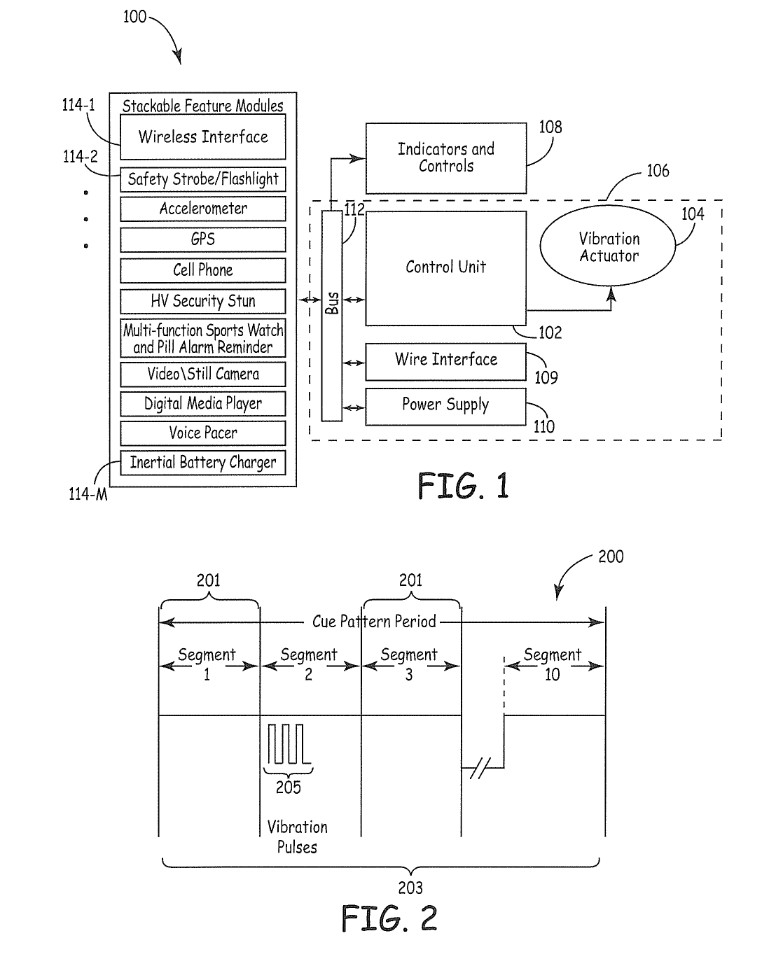

FIG. 1 is a high level block diagram of a vibratory exercise device 100 according to one embodiment of the present invention. Vibratory exercise device 100 includes control unit 102 coupled to vibration actuator 104 both located inside housing 106, in this example. However, in other embodiments, vibration actuator 104 is mounted individually apart from the housing of control unit 102. Separating control unit 102 and vibration actuator 104 enables more localized application of stimulation in some situations. Control unit 102 is adapted to provide signals to vibration actuator 104 at determined intervals to cause vibration actuator 104 to begin vibrating. Vibration actuator 104 provides sufficient vibration to enable a user that is in contact with housing 106 (e.g. holding the housing in a hand, strapping the housing to a limb, etc.) to feel the vibration. In some embodiments, vibration actuator 104 is an electromechanical device adapted to vibrate electromechanically. Alternatively, in other embodiments, vibration actuator 104 is adapted to produce sonic vibrations.

The vibrations provided by vibration actuator 104 serve as cues to help a user initiate movement. For example, users suffering from diseases causing akinesia/bradykinesia are able to better respond to the vibratory cues than to self-initiate movement. The cues, therefore, greatly improve the ability of such users to carry out the movements necessary for exercise. In addition, the cues can help a user regulate their movement regardless of whether or not the user suffers from akinesia/bradykinesia (e.g. the cues help a user move at a particular pace or to synchronize movement with another user).

Control unit 102 is responsible for controlling the frequency and duration of vibratory cues. A user is able to program the control unit using indicators and controls 108. Indicators and controls 108 are coupled to control unit 102 via bus 112. Bus 112 is a universal bus for providing both signals and power. In one example bus 112 is a Universal Serial Bus (USB). However, in other examples, other appropriate buses are used, such as an Institute of Electrical and Electronics Engineers (IEEE) standard 1394 compliant bus (also known as FireWire or i.Link). Control unit 102 is further adapted to be the bus controller in some embodiments.

Indicators and controls 108 provide both a user input mechanism and a visual and/or audio feedback mechanism. In some embodiments, control unit 102 is programmed with a plurality of cueing schemes from which a user selects the cueing scheme to be used via indicators and controls 108 (e.g. via a context menu). Additionally, in some embodiments, a user can use indicators and controls 108 to program a customized cueing scheme. For example, a user can input the number of steps to be taken in a given time period or a rate of movement, etc. Control unit 102 then uses the user input to determine when and for how long vibration actuator 104 should provide vibratory cues.

Also coupled to bus 112 is power supply 110. Power supply 110 in this example consists of standard sized disposable batteries (e.g. 9 volt, D cell or any other standard battery size). However, in other embodiments, a rechargeable battery such as a Ni—Li battery is used. In addition, in other embodiments, power supply 110 is a plug to be plugged into a standard electrical outlet. Power from power supply 110 is provided to control unit 102 and other components via bus 112. The size and type of battery used in a given embodiment is determined based on balancing weight and size constraints of vibratory exercise device 100 with power needs for the individual components.

In addition, in some embodiments, vibratory exercise device 100 includes wire interface 109. Wire interface 109 is used to interface with other electronic devices, such as a personal data assistant (PDA), a personal computer, etc. Therefore, wire interface 109 enables data to be transmitted between vibratory exercise device 100 and external electronic devices. As used herein, an external electronic device includes, but is not limited to, a personal data assistant, or a personal computer, etc. For example, exercise data (e.g. length of exercise time, rate of movement, etc.) can be transferred to a computer for clinical and/or personal use and tracking. In addition, cueing schemes as well as software or firmware updates can be transferred to vibratory exercise device 100 via wire interface 109.

Wire interface 109 also enables vibratory exercise device 100 to interface with one or more other vibratory exercise devices. In this manner, vibratory cues of each vibratory exercise device can be synchronized. Synclironization of the vibratory cues can be used to stimulate complex movement in a single user (e.g. movement requiring the use of more than one muscle group) and/or to synclironize movement between different users (i.e. group synclironization), each user having one or more vibratory exercise devices. Group synchronization is useful for simultaneously treating patients with sensory deficits and for use in group fitness programs. In some embodiments, control unit 102 is adapted to provide control signals via wire interface 109 to other vibratory exercise devices in order to provide parameters to the other vibratory exercise devices, such as when to vibrate and for how long. Alternatively, control unit 102 is adapted to respond to control signals received via wire interface 109 from another control unit, such as a control unit in another vibratory exercise device or in a central remote control.

In some embodiments, wire interface 109 is replaced with a wireless interface. A wireless interface facilitates use of multiple vibratory exercise devices 100, such as in a group setting, by eliminating wiring between devices. Alternatively, in some embodiments, neither a wire nor wireless interface is used to synchronize two or more vibratory exercise devices 100. In such embodiments, synclironization is accomplished by simultaneously initiating synchronization of a clock separately in each vibratory exercise device. In particular, in this example, when a mode button on indicators and controls 108 is held for a specific amount of time and released, the internal clock is reset. Thus, by depressing and releasing the mode button simultaneously on two or more vibratory exercise devices 100, the internal clock of each vibratory exercise is reset and synchronized with the other internal clock. Each vibratory exercise device 100 can then be adjusted individually relative to the synchronized clocks, e.g. adjustments to pulse width and phase.

In addition, a wireless interface is attached to vibratory exercise device 100 as a removable module in some embodiments of the present invention. In such embodiments, vibratory exercise device 100 is adapted to allow one or more removable modules 114-1 . . . 114-M to be attached to vibratory exercise device 100 and coupled to control unit 102 via bus 112. In addition, in some such embodiments, the modules are stackable. That is, one module may couple to another module which in turn is coupled to vibratory exercise device 100 or another module.

Examples of such modules include, but are not limited to, a wireless interface, a security stun device, a global positioning system (GPS) device, a sports watch, camera, media player, battery charger, cell phone, accelerometer, and flashlight. Some modules are used as accessories not related to aiding exercise, such as a stun device for protection or a cell phone. Other devices, however, are used to aid in the exercise program, such as an accelerometer. The accelerometer can be used both for informational purposes as well as to provide feedback to control unit 102 to maintain a particular pace, etc. Similarly, control unit 102 can be adapted to provide cues via vibration actuator 104 based on tempo changes in music played by a media player. In addition, a flashlight and audio device can be used to provide additional sensory cues to initiate movement. Since the modules are removable and stackable, new features can be continuously added via new modules.

In operation, a user programs control unit 102. This can be done with indicators and controls 108 or by connecting an external electronic device to control unit 102 via wire interface 109 or wireless interface module 114-1. Based on the user input, control unit 102 sends signals to vibration actuator 104 to control when and for how long a vibratory cue is produced. Vibration actuator 104 provides vibratory cues to the user while the user maintains contact with housing 106. Contact can be made, for example, by holding housing 106 in a hand or by strapping housing 106 to a limb. When vibration actuator produces a vibratory cue, the user will be able to respond to the stimulus and move the appropriate body part or muscle. In this way, vibratory exercise device 100 improves a user's ability to perform exercise movements. In particular, vibratory exercise device 100 is useful in helping users who suffer from peripheral sensory deficits. An additional advantage of vibratory exercise device 100 is that it is non-invasive (i.e. no insertion of electricity or physical material in the body) and, therefore, does not require supervision of a medical professional for its use. Therefore, vibratory exercise device 100 can be adapted to aid users in everyday routine movement in addition to being an exercise aid.

FIG. 2 is a diagram of a timing sequence 200 used in one embodiment of the present invention for providing vibratory cues. Timing sequence 200 is used by a control unit, such as control unit 102 to determine when a cue is to begin and for how long the cue should last. Timing sequence 200 uses cue pattern period 203. Cue pattern period 203, in this example, ranges from 0.1 seconds to 25 seconds. However, in other embodiments, other period ranges are used. When the end of cue pattern period 203 is reached, the control unit will begin the period again until instructed to stop.

Cue pattern period 203 is further divided into segments 201 (also referred to herein as phases). In this example, cue pattern period 203 is divided into 10 substantially equal length segments 201. However, it is to be understood by one of skill in the art that, in other embodiments, other appropriate numbers of segments 201 are used. For example, in one alternative embodiment, 8 segments 201 are used. The length of each segment 201 is based on the length of cue pattern period 203. For example, in this embodiment, since segments 201 are of substantially equal length, each of segments 201 has a duration 1/10^{th} of the duration (length) of cue pattern period 203. Although, the duration of segments 201 is substantially equal in this example, the duration of segments 201 does not have to be so arranged in other embodiments.

By dividing the cue period 203 into segments 201, the control unit can provide asymmetrical as well as symmetrical cues for one or more vibratory exercise devices, such as vibratory exercise device 100. For example, it may be desired to spend more time raising an arm than lowering an arm. To accomplish this, the control unit assigns a vibratory cue to two segments, one to stimulate raising and one to stimulate lowering the arm. By assigning a cue to the first segment to stimulate raising and a cue to the 7^{th} segment for lowering, 7/10 of cue period 203 can be spent on raising the arm while only 3/10^{th} are spent on lowering the arm. Similarly, movement can be synchronously or asynchronously coordinated between a plurality of vibratory exercise devices. For example, vibratory cues for each of two vibratory exercise devices, one in each hand, can be assigned to the same or different segments 201 in order to coordinate swinging both arms forward simultaneously or to coordinate the forward/back asynchronous swing of the arms such as during walking.

In addition, the duration of a vibration pulse 205 can also be adjusted. For example, it may be desirable to provide the vibratory cue for the entire movement of a muscle. In this case, the duration of pulse 205 is adjusted to match the desired length of time for completing movement of the muscle. Hence, assigning a cue to a segment 201 determines the start time for the cue and adjusting vibration pulse 205 determines the duration of the cue. The duration of vibration pulse 205 may be longer than the duration of a segment 201, in this example, and may overlap in time the vibration pulses of other vibratory exercise devices. However, in other embodiments, the duration of the vibration pulse 205 is fixed and only the start of the cue is adjustable based on cue assignments to one or more segments 201. Finally, the duration of each vibration pulse 205 used can be individually adjusted or a default duration can be used.

Another advantage to dividing cue period 203 into segments 201 is that the length of each segment 201 is dynamically adjusted to correspond to adjustments in the length of cue period 203. This is particularly useful when timing sequence 200 is used to synchronize two or more vibratory exercise devices. For example, if one vibratory exercise device is used on the left leg and another on the right leg, stimulating cues can be provided to each leg out of phase to support walking. In particular, in this example with 10 segments 201, by assigning a cue for the left leg to the first segment and a cue for the right leg to the sixth segment, the cues are 180 degrees out of phase. The walking pace can then be adjusted by merely adjusting the length of cue period 203 since the length of each segment 201 will correspondingly adjust.

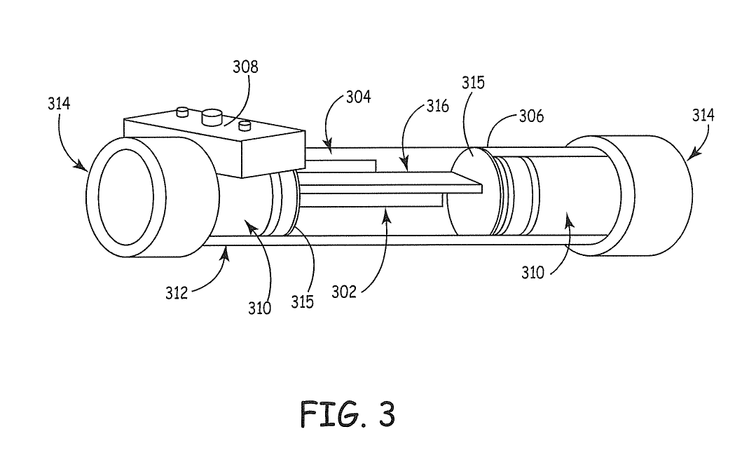

FIG. 3 is a vibratory exercise device 300 according to one embodiment of the present invention. Vibratory exercise device 300 is one example of vibratory exercise device 100. Housing 306 of vibratory exercise device 300 is a rounded baton shape. The baton shape is adapted for being handheld. In particular, the diameter of housing 306, in this example, is approximately 0.5 inches. However, it is to be understood that, in other embodiments, other shapes and/or dimensions are used. Inside housing 306 of vibratory exercise device 300 are control unit 302 and vibration actuator 304. Control unit 302 provides vibration actuator 304 with control signals to cause vibration actuator 304 to provide a vibratory cue as described above with regards to FIGS. 1 and 2.

In this example, control unit 302 and vibration actuator 304 are each coupled to printed circuit board 316 which is coupled to bus 312 via conductors 315. As described in FIG. 1, bus 312 is a universal bus which provides both signals and power to components of vibration exercise device 300. Also inside of housing 306 are batteries 310. In this example, batteries 310 are disposable batteries. However, in other embodiments, rechargeable batteries are used. Coupled to housing 306 and bus 312 are modules 314 and indicators and controls 308. Modules 314 provide additional functionality, as described above with respect to FIG. 1. Indicators and controls 308 are adapted to enable a user to program control unit 302. For example, in some embodiments, indicators and controls 308 present the user with a context menu from which the user selects a cueing scheme. Alternatively, a user inputs a desired pace, number of steps per minute, etc. via indicators and controls 308. Control unit 302 then calculates the proper timing for providing a vibratory cue based on the user input. In some embodiments, control unit 302 uses a timing sequence as described above with regards to FIG. 2 in calculating the proper timing and in providing vibratory cues via vibration actuator 304.

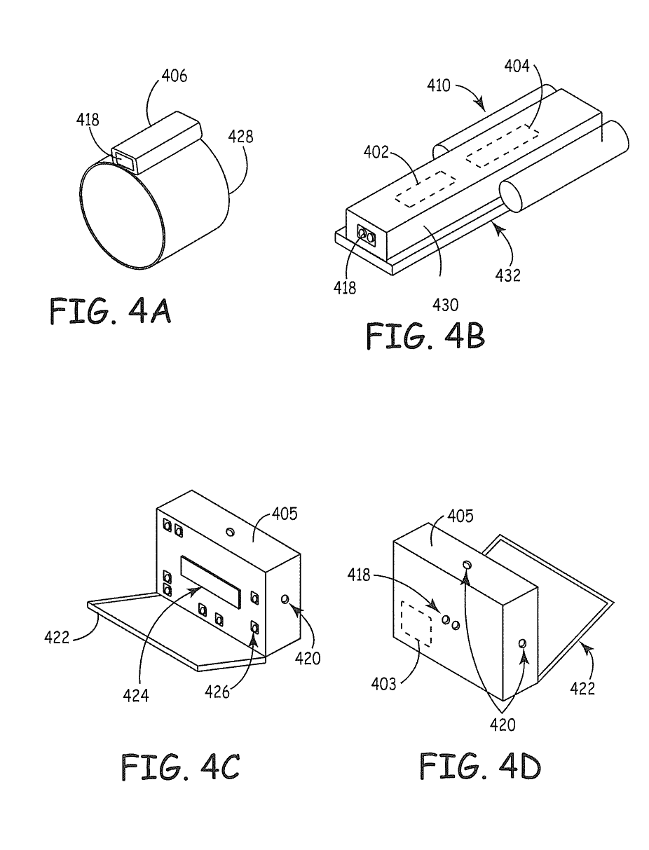

FIGS. 4A-4D depict components of a vibratory exercise device 400 according to one embodiment of the present invention. Vibratory exercise device 400 is another example of vibratory exercise device 100. FIG. 4A shows housing 406 coupled to band 428. Band 428 is adapted to be placed on a user's limb (e.g. an arm or leg). The circumference of band 428 is adjustable, in this example, so that band 428 can be placed on users of different size and on different parts of the user's body (e.g. forearm, bicep, thigh, calf, etc.). Housing 406 is adapted with a wireless interface 418, in this example. In particular, wireless interface 418, in this example, is an Infrared Data Association (IrDA) standard interface. Components inside housing 406 are shown enlarged in FIG. 4B.

As shown in FIG. 4B, components inside housing 406 include wireless interface 418, power supply 410, vibrating assembly 430, and contoured application area 432. Power supply 410 comprises two disposable batteries in this example. However, in other embodiments, other power supplies are used, such as rechargeable battery packs. Vibrating assembly 430 includes control unit 402 and vibration actuator 404. Contoured application area 432 is used to enhance contact with a user. Similarly, housing 406 is contoured on at least the side that contacts a user when used. The contour helps improve the ability of a user to sense the vibration cues. In other embodiments, vibration actuator 404 is not located in housing 406 with control unit 404 but is mounted separately from and connected to control unit 402 via a wire or wireless interface to facilitate finer positioning of the actuator.

Vibration assembly 430 receives signals from remote control 405 (shown in FIGS. 4C and 4D) via wireless interface 418. The signals received from remote control 405 instruct vibrating assembly 430 when to produce a vibration cue. In some embodiments, control unit 403 in remote control 405 transmits parameters to control unit 402 in vibrating assembly 430. Control unit 402 in vibrating assembly 430 then determines based on the parameters when to instruct vibration actuator 404 in vibrating assembly 430 when to provide a vibratory cue. In other embodiments, control unit 403 in remote control 405 determines when to instruct vibration actuator 404 to vibrate and transmits a signal each time vibration actuator 404 is to provide a vibratory cue. In such embodiments, the control unit 402 in vibrating assembly 430 instructs vibration actuator 404 to vibrate each time a signal is received from control unit 403. Control unit 402 in vibrating assembly 430 and control unit 403 in remote control 405 are described more fully above with regards to control unit 102 in FIG. 1.

The front of remote control 405 is shown in FIG. 4C and a rear-view of remote control 405 is shown in FIG. 4D. Remote control 405 includes display 424 for providing data to a user and controls 426 for receiving user input. For example, a user can use controls 426 and display 424 to select a cueing scheme or to enter parameters such as pace, steps/minute, etc. Remote control 405 also includes wireless interface 418 in this example. Wireless interface 418 in remote control 405 is also an IrDA interface in this example. In addition, wireless interface 418 is a bi-directional interface allowing communication between remote control 405 and vibrating assembly 430. Although an IrDA interface is used in this example, it is to be understood that other wireless or wired communication interfaces are used in other embodiments, such as IEEE 802.15.1 (e.g. Bluetooth) or IEEE 802.15.4 (e.g. ZigBee).

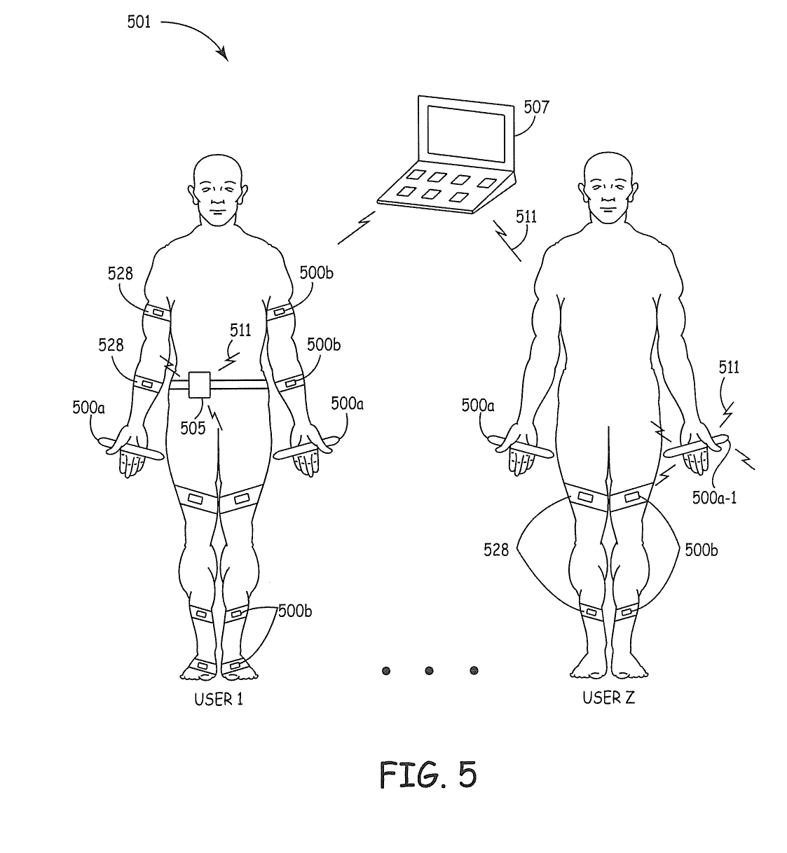

In addition, remote control 405 includes broadcast LEDs 420 along the perimeter of remote control 405. Broadcast LEDs are infrared (IR) emitters used for broadcasting periodic synchronization pulses. In this embodiment, remote control 405 is adapted to transmit signals to control a plurality of vibrating assemblies 430. The broadcast pulses instruct all of the vibrating assemblies 430 in the domain to execute the command. Other commands transmitted by remote control 405 include unique device IDs and instruct only the corresponding vibrating assembly 430 to respond. The unique device IDs are described below with regards to FIG. 5. Clip 422 is used to secure remote control 405 to a user's belt or clothing freeing up the user's hands while exercising.

FIG. 5 is a diagram showing an exercise aid system 501 according to one embodiment of the present invention. System 501 includes one or more users (user 1 . . . user Z, where Z is the total number of users). Each user has one or more vibratory exercise devices 500a and 500b. Vibratory exercise devices 500a are adapted to be held in a user's hand and are baton shaped similar to vibratory exercise device 300. Vibratory exercise devices 500b are adapted to be strapped to a user's body with bands 528 similar to vibratory exercise device 400. In addition, vibratory exercise devices 500b include, in one embodiment, remote control 505 similar to remote control 405. Remote control communicates with and controls other vibratory exercise devices 500b and 500a via communication link 511. Communication link 511 is a wireless communication link, in this example (e.g. IrDA, Bluetooth, etc.). However, in other embodiments, communication link 511 is a wired communication link.

However, in other embodiments, remote control 505 is replaced by one of vibratory exercise devices 500a. As shown with regards to user Z, vibratory exercise device 500a-1 communicates with and controls other vibratory exercise devices 500b and 500a via communication link 511. Communication link 511 is a wireless communication link, in this example (e.g. IrDA, Bluetooth, etc.). However, in other embodiments, communication link 511 is a wired communication link. Alternatively, external electronic device 507 is adapted to control vibratory exercise devices 500a and 500b via communication link 511. External electronic device 507 can be a personal data assistant, personal computer, etc. In addition, external electronic device 507 can be used to store and retrieve data from vibratory exercise devices 500a and 500b whether or not responsible for controlling vibratory exercise devices 500a and 500b.

The apparatus responsible for controlling vibratory exercise devices 500a and 500b (e.g. remote control 505, vibratory exercise device 500a-1, or external electronic device 507) coordinates synchronization of the devices to help the user perform synchronous and/or asynchronous movement. In some embodiments, the apparatus in control is adapted to control vibratory exercise devices 500a and 500b for all users within a given area. Alternatively, each user has a control apparatus which controls only the vibratory exercise devices 500a and 500b associated with that user.

In this example, synclironization of a plurality of vibratory exercise devices is accomplished by programming each vibratory exercise device 500a and 500b with a unique device ID. In this example the device ID is a 24 bit ID. However, in other embodiments, other device ID lengths are used. Additionally, in this example the device ID is programmed during manufacture and only the lower 8 bits of the device ID are used to address each vibratory exercise device 500a and 500b. When synclironization begins, the control apparatus broadcasts a command for all vibratory exercise devices 500a and 500b to report. If more than one device is powered on, a conflict will arise between the different devices 500a and 500b. The control apparatus then instructs the user to power off all the vibratory exercise devices 500a and 500b and to individually turn them back on. By sequentially turning on each vibratory exercise device 500a and 500b and broadcasting the report command, the control apparatus is able to generate a map of all the vibratory exercise devices 500a and 500b in the domain of control. If the control apparatus detects a conflict in device IDs, one vibratory exercise device is instructed to change its' address to one that does not conflict in the domain.

In operation, the control apparatus (e.g. remote control 505, vibratory exercise device 500a-1, or external electronic device 507) maps the vibratory exercise devices 500a and 500b to be controlled. A user then programs the control apparatus with parameters for an exercise routine. Such parameters include movements to be performed (e.g. movement of legs, arms, etc.), rate of movement, and so forth. The control apparatus has a control unit, such as control unit 102, which then determines the proper timing sequence for providing vibratory cues. The timing sequence used in this example involves dividing a cue pattern period into segments or phases, and assigning each of vibratory exercise devices 500a and 500b to one or more segments as described above with regards to FIG. 2. At the proper time, the control apparatus transmits, via communication link 511, control signals to vibratory exercise devices 500a and 500b to indicate when each is to vibrate. The vibration in this example is a physical vibration produced by an electromechanical vibrator. However, in other embodiments, a sonic vibration is used. The control apparatus either broadcasts the commands for all vibratory exercise devices 500a and 500b to respond or includes unique device IDs such that only the corresponding vibratory exercise devices 500a and 500b respond.

By reacting to the vibratory cues provided by vibratory exercise devices 500a and 500b, a user is able to initiate controlled movement. This responsive movement is more easily accomplished by users suffering from peripheral sensory deficits than self-initiated movement. In this manner, system 501 enables initiation of various movements both for an individual and a group. In addition, system 501 enables both synchronous and asynchronous movement of individuals and groups.

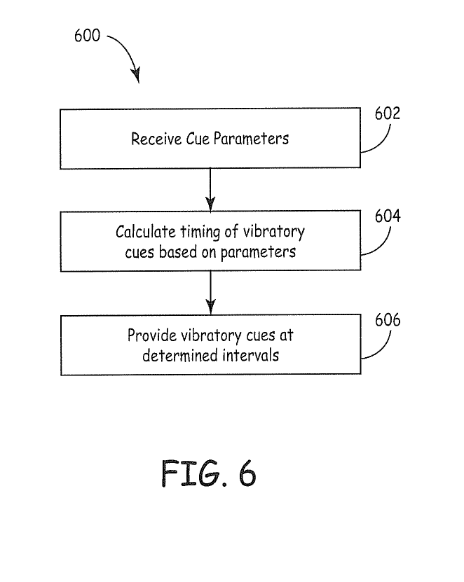

FIG. 6 is a flow chart showing a method 600 of facilitating movement during exercise according to one embodiment of the present invention. At 602, cue parameters are received in a vibratory exercise device, such as vibratory exercise device 100. The parameters include, but are not limited to, cue period duration, number of segments in the cue period, movement to be performed, number of repetitions of movement per a given time period, etc. The vibratory exercise device includes a control unit, such as control unit 102, and a vibration actuator, such as vibration actuator 104. The control unit and vibration actuator are located together in a housing, such as housing 306 or 406. The parameters are received from a user via a control and indicators, such as indicators and control 108 in FIG. 1, in this example. However, in other embodiments, the parameters are received via a communication interface such as, wire interface 109 or wireless interface 114-1. The communication interface couples the vibratory exercise device to an external electronic device such as a personal data assistant, personal computer, etc. The external electronic device then provides the cue parameters to the vibratory exercise device.

At 604, the control unit in the vibratory exercise device calculates the timing of vibratory cues based on the cue parameters received. In this example, the control unit calculates the timing based on dividing the duration of a cue pattern period into segments and assigning vibratory cues to one or more segments, as described above with regards to FIG. 2. At 606, the control unit instructs the vibration actuator to produce vibratory cues at the determined intervals (i.e. calculated timing of the cues). In this example the vibration actuator is an electromechanical device which physically vibrates. However, in other embodiments, the vibration actuator produces sonic vibrations. The vibratory cues are felt by a user that is in contact with the housing of the vibratory exercise device. Being contact with the housing includes, but is not limited to, holding the vibratory exercise device in the user's hand, and strapping the vibratory exercise device to a user's limb or extremity. When the user feels the vibratory cues, the user is able to more easily initiate movements in response to the cues.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

What is claimed is:

1. A vibratory exercise device, comprising:
a control unit adapted to determine when to provide vibratory cues, wherein the control unit is adapted to divide the duration of a cue pattern period into a plurality of segments, and to assign vibratory cues to one or more of the plurality of segments;
a vibration actuator coupled to the control unit and adapted to provide vibratory cues in response to control signals received from the control unit at the start of each segment assigned a vibratory cue; and
a housing adapted to house the control unit and the vibration actuator, wherein a user is able to feel the vibratory cues when in contact with the housing.

2. The vibratory exercise device of claim 1, wherein the vibration actuator produces one of electromechanical vibration and sonic vibration.

3. The vibratory exercise device of claim 1, wherein the housing is a baton shape adapted to be handheld.

4. The vibratory exercise device of claim 1, further comprising a user input device coupled to the control unit and adapted to pass cue parameters input from a user to the control unit, wherein the control unit determines when to provide vibratory cues based on the cue parameters.

5. The vibratory exercise device of claim 1, further comprising a remote control adapted to provide parameters and control signals to the control unit and vibration actuator.

6. The vibratory exercise device of claim 1, further comprising a communications interface coupled to the control unit to provide communication between the vibratory exercise device and other vibratory exercise devices.

7. The vibratory exercise device of claim 6, wherein the communications interface is a wireless interface.

8. The vibratory exercise device of claim 6, wherein the control unit is adapted to provide control signals to other vibratory exercise devices via the communications interface.

9. The vibratory exercise device of claim 6, wherein the communication interface is adapted to couple to an external electronic device such that the control unit stores data in and retrieves data from the external electronic device.

10. A vibratory exercise device comprising:
a control unit adapted to determine when to provide vibratory cues;
a vibration actuator coupled to the control unit and adapted to provide vibratory cues in response to control signals received from the control unit;
a housing adapted to house the control unit and the vibration actuator, wherein a user is able to feel the vibratory cues when in contact with the housing; and
one or more removable modules adapted to couple to the housing and the control unit.

11. The vibratory exercise device of claim 10, wherein the vibration actuator produces one of electromechanical vibration and sonic vibration.

12. The vibratory exercise device of claim 10, wherein the housing is a baton shape adapted to be handheld.

13. The vibratory exercise device of claim 10, further comprising a user input device coupled to the control unit and adapted to pass cue parameters input from a user to the control unit, wherein the control unit determines when to provide vibratory cues based on the cue parameters.

14. The vibratory exercise device of claim 10, wherein the control unit is further adapted to divide the duration of a cue pattern period into a plurality of segments, to assign vibratory cues to one or more of the plurality of segments, and to provide a control signal to the vibration actuator at the start of each segment assigned a vibratory cue.

15. The vibratory exercise device of claim 10, wherein the one or more removable modules further comprises one of an accelerometer, an audio device, and a flashlight.

16. The vibratory exercise device of claim 15, wherein the control unit is adapted to determine when to provide vibratory cues based in part on feedback from the accelerometer.

17. The vibratory exercise device of claim 15, wherein the control unit is adapted to provide control signals to the flashlight to provide visual cues.

18. The vibratory exercise device of claim 15, wherein the control unit is adapted to provide control signals to the audio device to provide auditory cues.

19. The vibratory exercise device of claim 10, further comprising a communications interface coupled to the control unit to provide communication between the vibratory exercise device and other vibratory exercise devices.

20. The vibratory exercise device of claim 19, wherein the communications interface is a wireless interface.

21. A vibratory exercise system comprising:
a communication link;
a plurality of vibratory exercise devices, each vibratory exercise device comprising:
a control unit adapted to determine when to provide vibratory cues, wherein the control unit is adapted to divide the duration of a cue pattern period into a plurality of segments, and to assign vibratory cues to one or more of the plurality of segments; and
one or more vibration actuators coupled to the control unit and adapted to provide vibratory cues in response to control signals received from the control unit; and
a control apparatus adapted to provide control signals to each of the plurality of vibratory exercise devices via the communication link, wherein the control unit in each of the plurality of vibratory exercise devices determines when to provide vibratory cues based on the control signals received from the control apparatus.

22. The vibratory exercise system of claim 21, wherein the communication link is a wireless communication link.

23. The vibratory exercise system of claim 21, wherein the control apparatus is one of a remote control, a control unit in one of the plurality of vibratory exercise devices, and an external electronic device.

24. The vibratory exercise system of claim 21, wherein at least one of the plurality of vibratory exercise devices further comprises one vibration actuator located in a housing with the control unit.

25. The vibratory exercise system of claim 24, wherein the housing of the at least one of the plurality of exercise devices is baton shaped.

26. The vibratory exercise system of claim 24, wherein the at least one of the plurality of vibratory exercise devices further comprises one or more removable modules.

27. A method of facilitating movement, the method comprising:
receiving cue parameters in a vibratory exercise device, the vibratory exercise device having a control unit and a vibration actuator located in a housing;
calculating the timing of vibratory cues with the control unit based on the cue parameters received; and
instructing the vibration actuator to produce vibratory cues based on the calculated timing of vibratory cues.

28. The method of claim 27, wherein receiving cue parameters further comprises receiving at least one of the cue period duration, the number of segments in the cue period, the movements to be performed, and the number of repetitions of movements per given time period.

29. The method of claim 27, wherein calculating the timing of vibratory cues further comprises:
dividing the duration of a cue pattern period into segments; and
assigning vibratory cues to one or more of the segments.

30. The method of claim 27, wherein instructing the vibration actuator to provide vibratory cues further comprises one of instructing the vibration actuator to vibrate electromechanically and instructing the vibration actuator to produce sonic vibrations.
